(19) United States
(12) Patent Application Publication
(10) Pub. No.: US 2025/0271182 A1
(43) Pub. Date: Aug. 28, 2025

(54) Magnetocaloric Temperature Control System with Enhanced Heat Transfer and Airflow Management

(71) Applicant: Matthew Edward Wuerth, Columbia, TN (US)

(72) Inventor: Matthew Edward Wuerth, Columbia, TN (US)

(21) Appl. No.: 19/193,792

(22) Filed: Apr. 29, 2025

(51) Int. Cl. F25B 21/00

(52) U.S. Cl. CPC F25B 21/00; F25B 2321/0023

(57) ABSTRACT

The invention is a modular magnetocaloric effect (MCE) temperature control system comprising a housing (100), an MCM stack (200), electromagnetic coils (300), a heat transfer system (400) with heat pipes (400) (e.g., 401, 402) and fins (500), a control system (700), baffles (600), an external fan (800), and an external power supply (900). Optional valves (400a) (e.g., 401a, 402a) enhance operational efficiency, making the system suitable for eco-friendly heating and cooling applications.

### FIELD OF THE INVENTION

The present invention relates to magnetocaloric temperature control systems, and more particularly to systems with enhanced heat transfer and airflow management.

### BACKGROUND OF THE INVENTION

Traditional heating, ventilation, and air conditioning (HVAC) systems often depend on refrigerants with high global warming potential (GWP) and energy-intensive compressors, leading to significant environmental and efficiency drawbacks. Magnetocaloric effect (MCE) technology provides a promising alternative by leveraging solid-state materials for refrigerant-free temperature control. However, existing MCE-based systems frequently suffer from inefficient heat transfer and suboptimal airflow management. The present invention addresses these limitations by introducing a modular, optimized magnetocaloric temperature control system suitable for applications such as HVAC, refrigeration, and beyond.

### SUMMARY OF THE INVENTION

The MCM-Air Pod is a modular, environmentally friendly temperature control system that utilizes the magnetocaloric effect to provide efficient heating and cooling. Key components include a housing (100), a magnetocaloric material (MCM) stack (200), electromagnetic coils (300), an excess heat transfer system (400-500) featuring heat pipes (e.g., 401, 402) and fins (500), a control system (700), airflow-guiding baffles (600), an external fan (800), and an external power supply (900). Optional valves (400a) (e.g., 401a, 402a) are included to further enhance system efficiency.

### BRIEF DESCRIPTION OF THE DRAWINGS

FIG. 1: Isometric view of the MCM-Air Pod, illustrating the housing (100), MCM stack (200), electromagnetic coils (300), heat pipes (400) (e.g., 401, 402), fins (500), baffles (600), and external fan (800).

FIG. 2: Top view detailing the arrangement of MCM plates (e.g., 201, 202), electromagnetic coils (300), heat pipes (400), fins (500), and baffles (600).

FIG. 3: Side view depicting airflow through the MCM stack (200), directed by baffles (600).

FIG. 4: Detailed view of the MCM stack (200) and its integration with baffles (600).

FIG. 5: Cross-sectional view showing heat transfer through heat pipes (400) (e.g., 401, 402) and fins (500), with optional valves (400a) (e.g., 401a, 402a).

FIG. 6: Schematic of the control system (700), including the external power supply (900) and its electrical connections to the electromagnetic coils (300), control system (700), and other components.

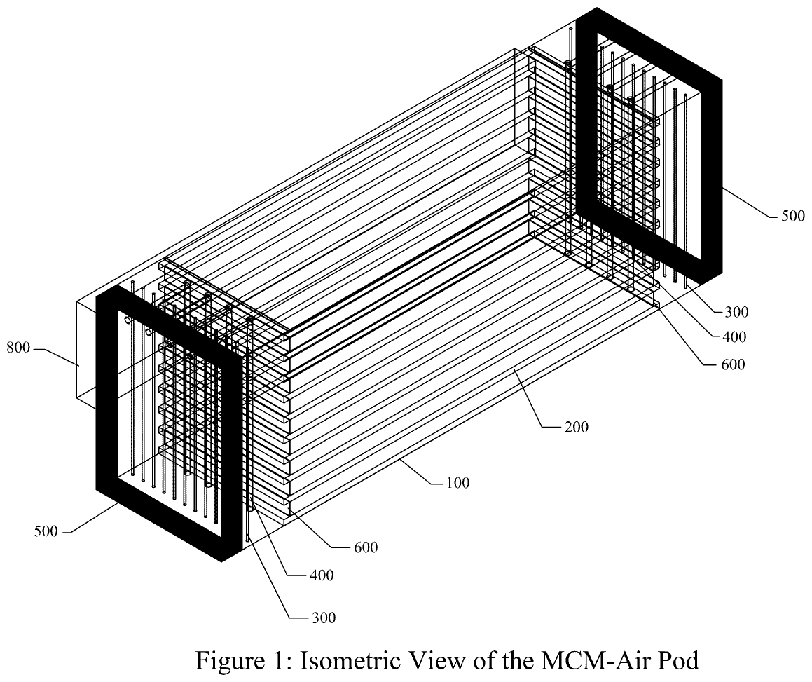

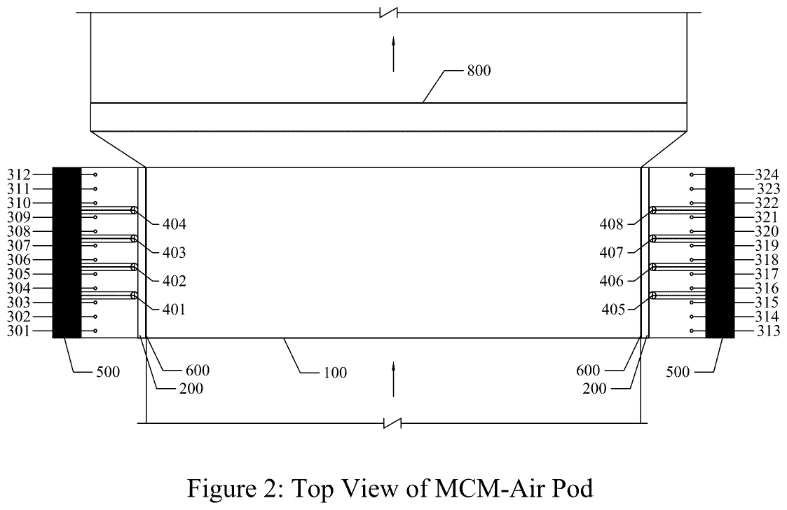

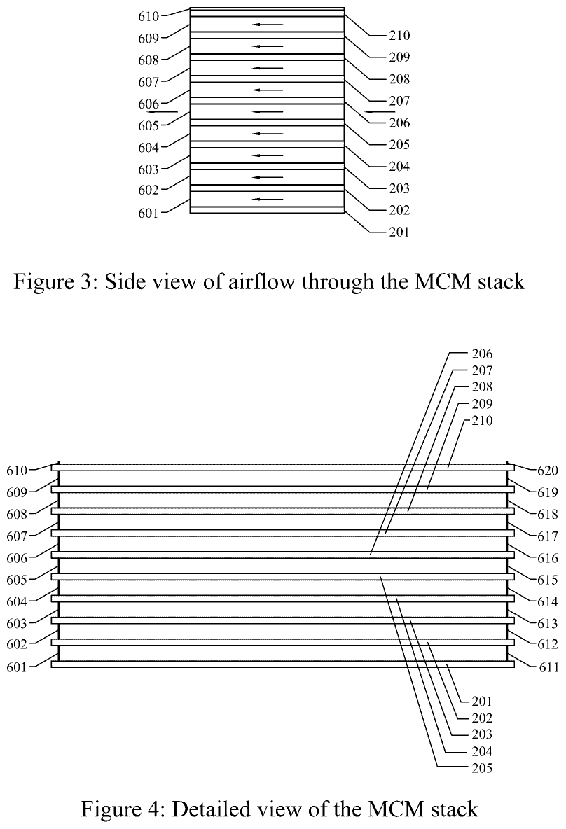

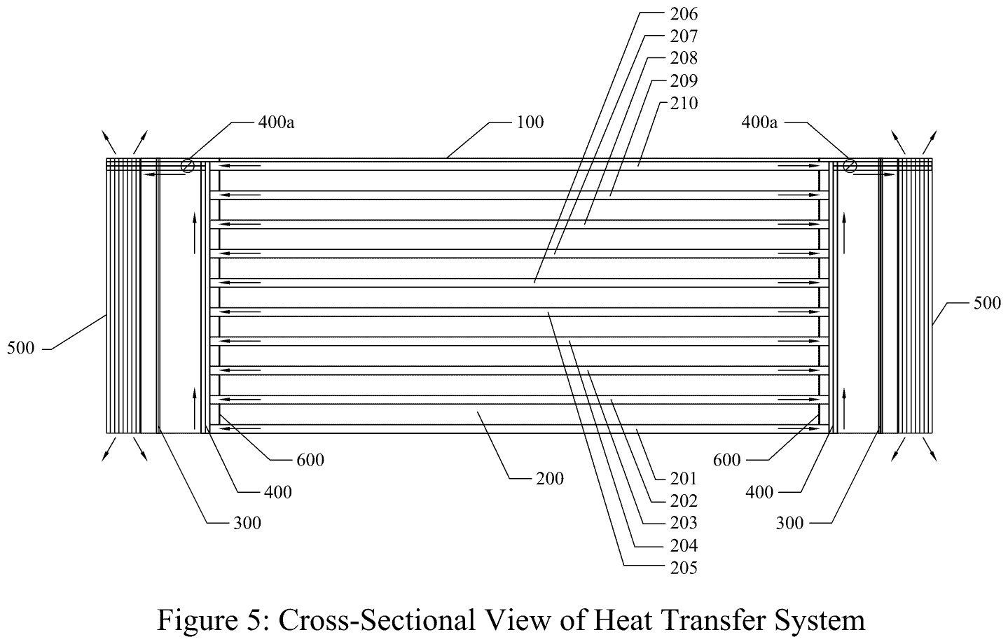

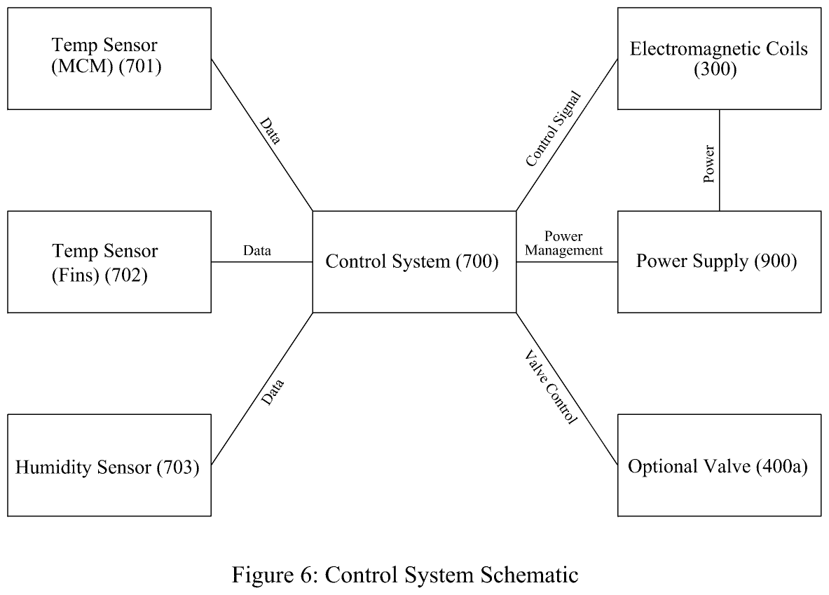

### DETAILED DESCRIPTION OF THE INVENTION

The MCM-Air Pod leverages the magnetocaloric effect (MCE) to deliver efficient, refrigerant-free temperature regulation. Its modular design, combined with optimized heat transfer and airflow management, ensures versatility across various applications.

### System Components

### Housing (100):

Made of thermally conductive materials (e.g., aluminum alloy), the housing (100) encases all components. It includes front and back openings for airflow and side-mounted baffles (600) to direct air across the MCM stack (200).
Dimensions: Approximately 24 inches long, 12 inches wide, and 18 inches high (adjustable based on application or capacity).

### MCM Stack (200):

Consists of multiple MCM plates (e.g., 201, 202), each approximately 0.125-0.5 inches thick, spaced 0.5-0.75 inches apart to facilitate airflow for direct thermal exchange, variable based on application. Materials include lanthanum-iron-silicon (LaFeSi) or gadolinium (Gd).
Plate count varies by application (e.g., 10-50 plates).
In a preferred embodiment, the MCM plates (200) are made from LaFeSi alloys for air conditioning applications due to their high magnetocaloric effect near room temperature

### Electromagnetic Coils (300):

Positioned adjacent to the MCM stack (200), the coils (300) cycle a magnetic field to induce MCE-based heating and cooling, managed by the control system (700).
Typical field strength: 1-2 Tesla, adjustable via control settings.

### Heat Transfer System (400-500):

Comprises a plurality of heat pipes (400) (e.g., 401, 402) thermally linked to the MCM stack (200), extending through external fins (500) for heat dissipation.
Heat Pipes (400): Copper or aluminum, approximately 0.5 inches in diameter, containing a working fluid (e.g., ammonia). Variable based on application.
External Fins (500): Aluminum, positioned outside the housing (100), approximately 12 inches by 12 inches per fin array. Variable based on application.
Optional Heat Pipe Control Valves (400a): Each heat pipe (e.g., 401, 402) may include a corresponding valve (e.g., 401a, 402a) to regulate fluid flow. In heating mode, valves (400a) (e.g., 401a, 402a) close to retain heat; in cooling mode, they open to transfer heat to the fins (500).

### Baffles (600):

Constructed from reinforced polymer or metal, integrated into the housing (100) to guide airflow through the MCM stack (200), preventing bypass and optimizing heat exchange.
Positioned in between each MCM plate.

### Control System (700):

An electronic unit managing magnetic field cycling, airflow, and valve (400a) operation (if equipped) using real-time sensor data (e.g., temperature, humidity).
Temperature sensors monitor the MCM stack to adjust magnetic field frequency,
Programmable for specific applications (e.g., air conditioning, refrigeration).
   The control system (700) uses temperature sensors to adjust the magnetic field frequency between 1 and 10 Hz based on MCM stack (200) temperature

### External Fan (800):

An optional component to enhance airflow, positioned at the front or back opening of the housing (100), typically 10-12 inches in diameter, with adjustable speed. Variable based on application.

### External Power Supply (900):

A direct current (DC) power source, configured to power the system. Variable based on application. It supplies electricity to the electromagnetic coils (300), control system (700), and external fan (800). The power supply includes safety features such as overcurrent protection and thermal shutdown to ensure reliable operation.

### Airflow Management

Air enters through the front opening of the housing (100), flows across the MCM stack (200) guided by baffles (600), and exits via the back opening. The external fan (800) drives this process. This confined airflow path maximizes thermal exchange between the air and MCM plates (e.g., 201, 202), ensuring efficiency and simplicity.

### Operation

The MCM-Air Pod operates in two primary modes: cooling and heating, controlled by the cyclic application of the magnetic field and airflow management.

### Cooling Mode:

The control system (700) cycles the magnetic field, causing the MCM plates (e.g., 201, 202) to absorb heat from the airflow. Open heat pipe valves (400a) (e.g., 401a, 402a) allow heat transfer through the heat pipes (400) (e.g., 401, 402) to the external fins (500) for dissipation.

### Heating Mode:

The MCM plates (e.g., 201, 202) release heat into the airflow during magnetic field cycling. Closed valves (400a) (e.g., 401a, 402a) prevent heat loss to the fins (500), warming the exiting air.

### Scalability and Adaptability

Capacity: Adjustable by modifying the number of MCM plates (e.g., 201, 202), coil (300) strength, or heat transfer components (400, 401, 500).
Temperature Range: Achieved by selecting MCM materials (e.g., LaFeSi for air conditioning, MnFePAs for freezing).
Flexibility: Modular units can be stacked, and fin (500) placement adapts to installation environments (e.g., attics, rooftops).

### EXAMPLES

Example 1: Residential 1-ton unit with LaFeSi plates (e.g., 201, 202), optional valves (400a), and a single fan (800).
Example 2: Commercial 5-ton unit with Gd plates (e.g., 201, 202), enhanced baffles (600), and multiple fins (500).
Example 3: Industrial freezer with MnFePAs plates (e.g., 201, 202), valves (400a), and high-capacity coils (300).

1. A magnetocaloric temperature control system comprising:
a) a housing (100) with front and back openings for airflow;
b) a stack of magnetocaloric material (MCM) plates (200) within the housing (100) for direct thermal interaction with airflow;
c) electromagnetic coils (300) adjacent to the stack (200) to generate a cycling magnetic field;
d) a heat transfer system (400) thermally coupled to the stack (200), including heat pipes (e.g., 401, 402) extending through external fins (500) outside the housing (100);
e) a control system (700) managing the magnetic field and operational modes; and
f) baffles (600) within the housing (100) directing airflow through the stack (200).

2. The system of claim 1, further comprising heat pipe control valves (400a) (e.g., 401a, 402a) corresponding to each heat pipe (e.g., 401, 402).

3. The system of claim 2, wherein the valves (e.g., 401a, 402a) regulate working fluid flow within the heat pipes (e.g., 401, 402).

4. The system of claim 3, wherein in heating mode, the valves (e.g., 401a, 402a) close to retain heat within the system.

5. The system of claim 3, wherein in cooling mode, the valves (e.g., 401a, 402a) open to transfer heat to the fins (500).

6. The system of claim 2, wherein the control system (700) adjusts the valves (400a) based on operational mode.

7. The system of claim 1, wherein the control system (700) adjusts magnetic field cycling frequency based on application needs.

8. The system of claim 1, further comprising an external fan (800) enhancing airflow through the housing (100).

9. The system of claim 1, further comprising an external power supply (900) powering the coils (300) and control system (700).

10. The system of claim 9, wherein the external power supply (900) is adaptable to multiple voltage inputs for diverse applications.

11. The system of claim 1, wherein the magnetocaloric material (MCM) plates (200) are made from materials selected from the group consisting of lanthanum-iron-silicon (LaFeSi) alloys, gadolinium (Gd), manganese-based alloys, and other magnetocaloric compounds.

12. The system of claim 1, wherein the baffles (600) are positioned on both sides of the stack (200) to optimize airflow.

13. The system of claim 1, wherein the heat pipes (e.g., 401, 402) extend vertically along the stack (200) for efficient heat transfer.

14. The system of claim 1, wherein the system is modular, allowing additional MCM plates (e.g., 201, 202) for scalability.

15. A method of controlling temperature using a magnetocaloric system, comprising:
a) providing a stack of MCM plates (200) within a housing (100);
b) applying a cycling magnetic field via electromagnetic coils (300);
c) directing airflow through the stack (200) using baffles (600);
d) transferring heat via heat pipes (e.g., 401, 402) to external fins (500); and
e) regulating heat pipe fluid flow with valves (e.g., 401a, 402a) for operational efficiency.
